(19) United States
(12) Patent Application Publication
(10) Pub. No.: US 2016/0311598 A1
(43) Pub. Date: Oct. 27, 2016

(54) Resealable Flexible Packages

(71) Applicants: Brian R. O'Hagan, Appleton, WI (US); Jordan R. Tracy, Appleton, WI (US)

(72) Inventors: Brian R. O'Hagan, Appleton, WI (US); Jordan R. Tracy, Appleton, WI (US)

(21) Appl. No.: 14/692,967

(22) Filed: Apr. 22, 2015

(51) Int. Cl. B65D 75/58; B32B 1/02; B65D 65/14; B32B 7/06; B65D 65/40; B65D 75/30

(52) U.S. Cl. CPC B65D 75/5844; B65D 65/40; B65D 75/30; B65D 65/14; B32B 7/06; B32B 1/02; B65D 2575/586; B32B 2250/02; B32B 2439/00

(57) ABSTRACT

A resealable flexible package includes a closed position wherein a removable portion is defined in a film by a first line of weakness and a second line of weakness; an open position wherein the removable portion is fully separated along the first line of weakness and the second line of weakness to expose at least a portion of a pressure sensitive adhesive layer and to define a mouth; and a resealed position, wherein at least two sections of an exposed portion of the pressure sensitive adhesive layer are in contact to close the mouth.

### TECHNICAL FIELD

The present disclosure relates generally to the field of packages. More specifically, the present disclosure relates to flexible packages that are resealable.

### SUMMARY

Resealable flexible packages are provided that have integrated features to provide for reseal. Separating a removable portion of a film from which the package is made both defines a mouth and exposes at least a portion of a pressure sensitive adhesive layer that seals to itself to provide for reseal.

An exemplary embodiment relates to a resealable flexible package including a closed position, an open position and a resealed position. The package comprises a film. The film includes at least an exterior layer and an interior layer. At least one wall of the package is formed from the film. The wall comprises a first line of weakness extending generally into the exterior layer; a second line of weakness extending generally into the interior layer; a patterned release coating layer disposed generally between the exterior layer and the interior layer; and a pressure sensitive adhesive layer disposed at least generally between the patterned release coating layer and the interior layer. In the closed position, a removable portion is defined in the film generally by the first line of weakness and the second line of weakness. In the open position, the removable portion is separated along the first line of weakness and the second line of weakness to expose at least a portion of the pressure sensitive adhesive layer and to define a mouth. In the resealed position, at least two sections of the exposed portion of the pressure sensitive adhesive layer are in contact to seal the mouth.

In some embodiments, the patterned release coating layer generally corresponds to a lateral offset between the first line of weakness and the second line of weakness.

In some embodiments, the pressure sensitive adhesive layer is a patterned pressure sensitive adhesive layer. In some of these embodiments, the patterned pressure sensitive adhesive layer at least generally corresponds to a lateral offset between the first line of weakness and the second line of weakness.

In some embodiments, the wall further comprises a flood-coated laminating adhesive layer directly adjacent to the interior layer.

In some embodiments, in the resealed position, the removable portion of the wall is fully removed and not involved in reseal.

In some embodiments, the first line of weakness circumscribes the second line of weakness.

In some embodiments, the wall comprises a gusseted feature.

Another exemplary embodiment relates to a resealable flexible package comprising a multilayered film defining at least one wall; a first line of weakness extending into at least the outermost layer of the multilayer film; a second line of weakness extending into at least the innermost layer of the multilayer film, the second line of weakness circumscribed by the first line of weakness; a pressure sensitive adhesive layer having at least a portion disposed generally between the first line of weakness and the second line of weakness; and a removable portion of the multilayer film defined generally by the first line of weakness and the second line of weakness. Upon removal of the removable portion, a mouth of the package is defined and at least a portion of a pressure sensitive adhesive layer of the film is exposed.

In some embodiments, the removable portion is removed from a remaining portion of the package along a separation interface, the separation interface including the interface between the pressure sensitive adhesive layer and a patterned release coating layer, the interface of the pressure sensitive adhesive layer and the patterned release coating layer being between the first line of weakness and the second line of weakness.

In some embodiments, the removable portion is removed from a remaining portion of the package along a separation interface, the separation interface extending completely through the multilayer film at a location substantially corresponding to the second line of weakness.

In some embodiments, the outermost layer comprises an oriented film. In some of these embodiments, the outermost layer comprises a biaxially oriented polyethylene terephthalate (OPET). In other of these embodiments, the outermost layer comprises an oriented polypropylene (OPP).

In some embodiments, the innermost layer comprises a polyolefin, a polyester, a polystyrene, or combinations thereof. In some of these embodiments, the innermost layer comprises an ethylene/vinyl acetate copolymer or polypropylene.

In some embodiments, an ink layer is disposed on a surface of the outermost layer. In some of these embodiments, the ink layer is reverse-printed on an inner surface of the outermost layer.

In some embodiments, the outermost layer of the multilayered film comprises a polyester or an oriented polyolefin and an innermost layer comprising a polyolefin, a polyester, a polyamide, a polystyrene, or blends thereof.

Still another exemplary embodiment relates to a multilayer film for a resealable flexible package. The multilayer film comprises an exterior layer; an interior layer; a patterned release coating layer disposed generally between the exterior layer and the interior layer; a pressure sensitive adhesive layer disposed adjacent to the patterned release coating layer, the pressure sensitive adhesive layer being generally proximate the interior layer relative to the patterned release coating layer; a first boundary circumscribing a second boundary, the second boundary substantially corresponding to an inner boundary of the patterned release coating layer within which there is an absence of the patterned release coating layer; and an interface along which the patterned release coating layer and the pressure sensitive adhesive layer are separated to define a flange upon application of a peeling force proximate to the first boundary and the second boundary.

In some embodiments, the interface substantially corresponds to an offset between the first boundary and the second boundary.

In some embodiments, the patterned release coating layer further includes an outer perimeter, the outer perimeter generally corresponding to the first boundary. According to some of these embodiments, the pressure sensitive adhesive layer further includes an inner boundary, there being an absence of pressure sensitive adhesive within the inner boundary. According to other of these embodiments; the inner boundary of the pressure sensitive adhesive layer generally corresponds to the second boundary.

In some embodiments, the package further comprises a first line of weakness extending generally into the exterior layer and substantially corresponding to the first boundary.

In some embodiments, the multilayer film further comprises a second line of weakness extending generally into the interior layer and substantially corresponding to the second boundary.

In some embodiments, the multilayer film further comprises a laminating adhesive layer.

In some embodiments, the multilayer film further comprises an ink layer on an inner surface of the exterior layer.

Still another exemplary embodiment relates to a resealable flexible package comprising a top panel. The top panel comprises a film that includes a release coating layer and a pressure sensitive adhesive layer that are between at least an exterior layer and an interior layer and a body. The top panel has a peelable margin comprising a portions of the interior layer and at least a portion of the pressure sensitive adhesive layer, the peelable margin defining a mouth for access to the inside of the package. The top panel also comprises at least one biased seam generally corresponding to a line of symmetry of the peelable margin.

According to some embodiments, a method of delivering and storing a food product comprises obtaining the resealable flexible package containing the food product; rupturing the first line of weakness and the second line of weakness to completely separate the removable portion and to provide access the food product through the mouth; contacting sections of the pressure sensitive adhesive layer to close access to the mouth; and storing remaining food product without the need for the removable portion.

Still another exemplary embodiment relates to a method of making a resealable flexible package comprising providing an exterior layer; providing an interior layer; pattern-applying a release coating layer; applying a pressure sensitive adhesive layer; laminating at least the exterior layer, interior layer, release coating layer and pressure sensitive adhesive layer to form a multilayer film; imparting a first line of weakness generally into the exterior layer; imparting a second line of weakness generally into the interior layer; and forming at least one wall from the multilayer film.

In some embodiments, the method further comprises applying the pressure sensitive adhesive layer is achieved by pattern-applying the pressure sensitive adhesive layer.

In some embodiments, the method further comprises reverse printing an ink layer on an interior surface of the exterior layer.

In some embodiments, the method further comprises flood coating a laminating adhesive. In some embodiments, flood coating occurs after the steps of pattern-applying a release coating layer and applying a pressure sensitive adhesive layer.

These and other embodiments/aspects of the invention are described in the detailed description below. In no event should the above summary be construed as a limitation on the claimed subject matter.

### BRIEF DESCRIPTION OF THE DRAWINGS

The disclosure may be more completely understood in consideration of the following detailed description of various embodiments of the disclosure in connection with the accompanying drawings, in which:

FIG. 1 is a top plan perspective exploded view of an exemplary flexible package in an open position;

FIG. 2A is a cross-sectional schematic of an exemplary film used to form a resealable flexible package shown in an open position;

FIG. 2B is a perspective cross-sectional schematic of the exemplary film of FIG. 2A;

FIG. 3 is a cross-section schematic of another exemplary film used to form a resealable flexible package shown in an open position;

FIG. 4 is a top perspective view of the exemplary flexible package of FIG. 1 in a closed position;

FIG. 5 is a cross-sectional schematic of the exemplary film of FIG. 2A in a closed position;

FIG. 6 is a schematic plan view along line A-A of FIG. 5;

FIG. 7 is a schematic plan view along line B-B of FIG. 5;

FIG. 8 is a cross-sectional schematic of the exemplary film of FIG. 3 in a closed position;

FIG. 9 is a top perspective view of another exemplary flexible package in a closed position;

FIG. 10 is a top perspective view of the exemplary flexible package of FIG. 1 in a resealed position;

FIG. 11 a side perspective view of exemplary flexible package of FIG. 9 in a resealed position;

FIG. 12 is a top perspective view of another exemplary flexible package in a closed position;

FIG. 13 is a top perspective view of the exemplary flexible package of FIG. 12 in an open position;

FIG. 14 is a top plan perspective view of the exemplary flexible package of FIG. 12 in a resealed position; and

FIG. 15 is a partial cross-sectional view of the exemplary resealed package of FIG. 10 along line C-C.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are resealable flexible packages having integral features that provide for reseal.

Many prior art resealable flexible packages rely on add-on components to provide for resealability. These add-ons typically increase cost, manufacturing steps, and material handling. Examples of add-on components commonly used to provide for resealability include press-to-close (PTC) zippers and applied elements (e.g., peel or pull tabs independent of the film used to form the body of a package itself, etc.).

Other prior art resealable flexible packages utilize resealable flaps. Many resealable flaps are not integral with the package, providing for some of the same disadvantages of other add-ons, like PTC zippers. Resealable flaps and labels, whether integral with the package or not, have further disadvantages in that these flaps may obstruct or otherwise interfere with access to a product within a package when the package is in the open position (e.g., because the resealable flap is still attached and may thereby partially obstruct access to the corresponding package opening, because the resealable flap may stick to the hand of a consumer using the package, etc.).

Still other prior art resealable packages require a user must keep track of a sticker, label, or other similar element when the package is open (i.e., fully detached elements required for reseal). Such elements are prone to being lost or compromised (e.g., losing their ability to reseal due to contact with contaminants, etc.), preventing a consumer from utilizing the reseal functionality of the package.

Excellent resealing of the resealable flexible packages herein is achieved by fully removing a removable portion to define a mouth and expose a pressure sensitive adhesive. In the resealed position, the pressure sensitive adhesive is used to form the seal. The removable portion is not required for reseal; thus, a consumer need not keep track of the removable portion to utilize the reseal functionality of the package. Further, there are no add-ons. The removable portion is integral with a film used to form the package and the pressure sensitive adhesive is exposed from within the same film itself. Further still, the mouth is unobstructed by an element required for reseal when in use in the open position.

The packages disclosed herein provide storage and protection for products that are disposed therein. The product may be any product that would benefit from protection and/or storage by the packages of this disclosure. The packages of this disclosure are particularly beneficial for products that may not be entirely consumed or otherwise utilized at one time (e.g., shelf-stable snacks, candy, dried fruit, shaving blades, fishing lures, etc.). For these products, the resealability of the package allows the product to remain in the package after an initial use and be stored therein until a later use. Thus, a consumer avoids the need to transfer the product to another receptacle for storage after opening and benefits from the package being already configured to properly store and protect the product therein.

Referring generally to the FIGURES, disclosed herein are packages and (e.g., packages 100, 200 and 300) that are resealable, flexible packages that include a closed position, an open position, and a resealed position. The packages can be transitioned from the closed position to the open position. The packages can also be repeatedly transitioned between the open position and the resealed position. Also disclosed herein are films from which these packages may be manufactured. It should be noted that the films as shown in the FIGURES do not reflect actual proportions, but rather are shown with some layers exaggerated for ease of explanation and clarity (e.g., the pressure sensitive adhesive layer and the release coating layer are in reality much thinner relative to the interior layer and exterior layer).

The configuration of the packages is such that transitioning a package from one position to another is intuitive for a consumer. Significantly, in a single step a consumer can both open the package and expose a pressure sensitive adhesive that provides for the package to be transitioned from the open position to the resealed position. It is also significant that when transitioning the package between the open position and the reseal position, a consumer need not keep track of removable portion for reseal or navigate a flap or other feature that is only partially separated in the open position.

The packages of this disclosure are also configured to be efficiently manufactured (e.g., no add-ons are required, easy to run on existing equipment without the need for expensive retrofits or additional processing steps, etc.) as will be readily appreciated by one of skill in the art. It is anticipated that the packages will be commonly utilized in applications wherein the package is considered disposable. For such applications, a package configuration that is overly complex or otherwise does not lend itself to efficient manufacture is generally cost and/or time prohibitive.

Other benefits of the packages are numerous and will be apparent upon review of this disclosure.

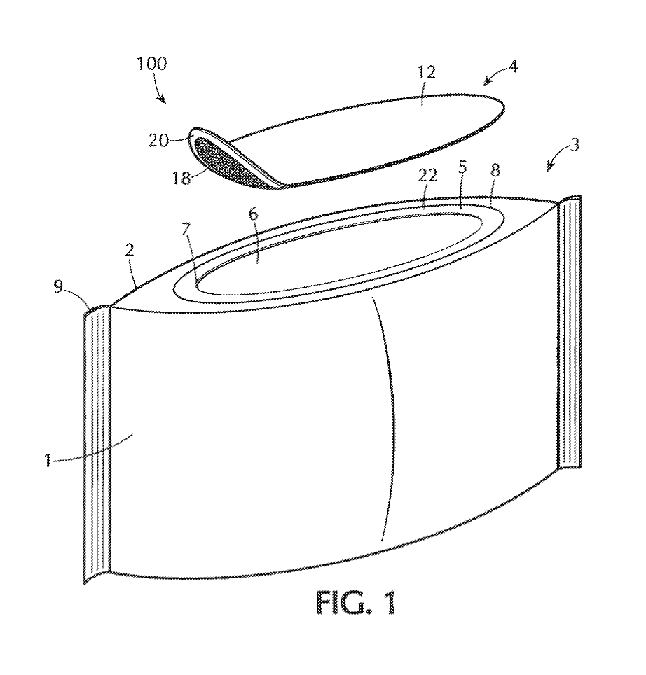

FIG. 1 shows a flexible package 100 comprising a body 1, an access wall shown as a top panel 2, a remaining portion 3 and a removable portion 4 according to an exemplary embodiment. Generally, the access wall may be any panel, wall or other portion of the film/package suitable to include the removable portion and thereby provide for access to product in the package. In the present embodiment, the top panel 2 includes the removable portion 4.

Top panel 2 comprises an interior layer 18, an exterior layer 12 generally located such that it is directly subject to handling and the environment when the package is formed, a release coating or varnish layer shown as a patterned release coating layer 20 and a pressure sensitive adhesive layer 22. The patterned release coating layer 20 is adjacent the pressure sensitive adhesive layer 22, thereby facilitating separation of the removable portion 4 (e.g., by adhesive failure).

In the present embodiment, the interior layer is shown as the innermost layer (i.e., adjacent to the product when the package is formed).

According to an exemplary embodiment, the interior layer is a sealant layer comprising a sealant film. The sealant layer is configured to seal to itself to form a seal (e.g., a thermoplastic polymer or polymer mixture that softens when exposed to heat and returns to its original condition when cooled to room temperature). According to one exemplary embodiment, the interior layer comprises an ethylene/vinyl acetate copolymer or polypropylene. In general, the sealant film may comprise any suitable thermoplastic material including, but not limited to, synthetic polymers such as polyesters, polyolefins, polystyrenes, and the like. Thermoplastic materials may also include any synthetic polymer that is cross-linked by either radiation or chemical reaction during a manufacturing or post-manufacturing process operation. Exemplary polyolefins include polyethylene (PE) and polypropylene (PP), polyolefin, a polyester, a polystyrene, or combinations thereof.

According to an exemplary embodiment, the patterned release coating layer comprises FSBM1B6DB produced by Siegwerk Druckfarben AG & Co. KGaA. According to other exemplary embodiments, the patterned release coating layer may be any coating suitable to function as described herein, as would be understood by one of skill in the art.

According to an exemplary embodiment, the pressure sensitive adhesive may comprise an elastomeric first component and a tackifier second component. The elastomeric first component may comprise a styrene/rubber copolymer selected from the group consisting of: polystyrene/butadiene/styrene (SBS), polystyrene/isoprene/styrene (SIS), polystyrene/ethylene-butylene/styrene (SEBS), and polystyrene/ethylene-propylene/styrene (SEPS), or blends of any of these materials, and the tackifier second component may comprise a terpene resin or a petroleum hydrocarbon resin. In general, the pressure sensitive adhesive may be any pressure sensitive adhesive suitable for providing the functionality as described herein, as would be understood by one of skill in the art.

According to an exemplary embodiment, the pressure sensitive adhesive is an acrylic emulsion pressure sensitive adhesive.

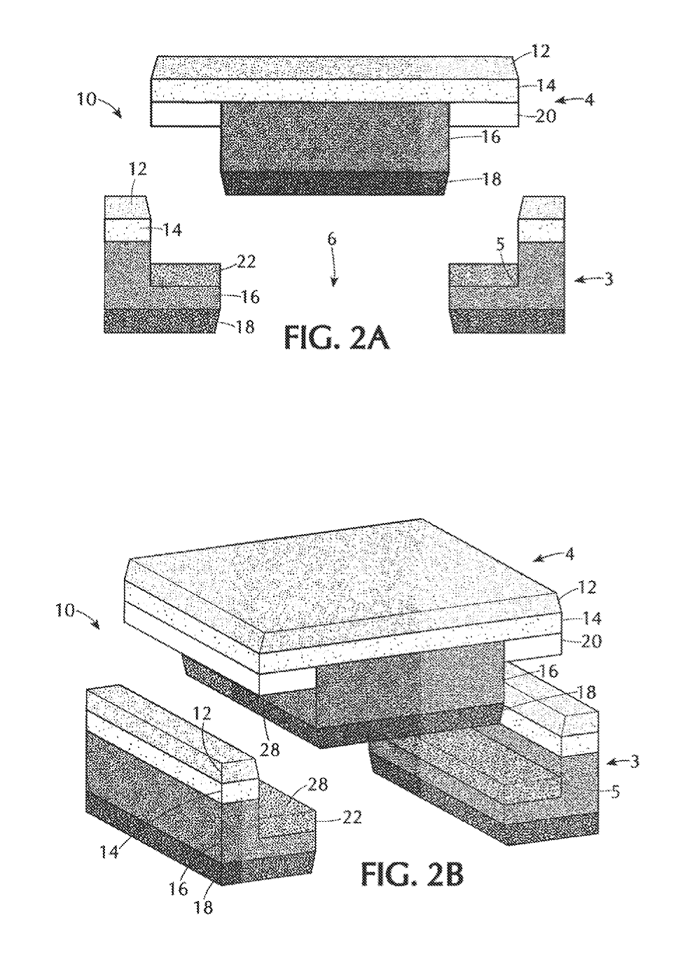

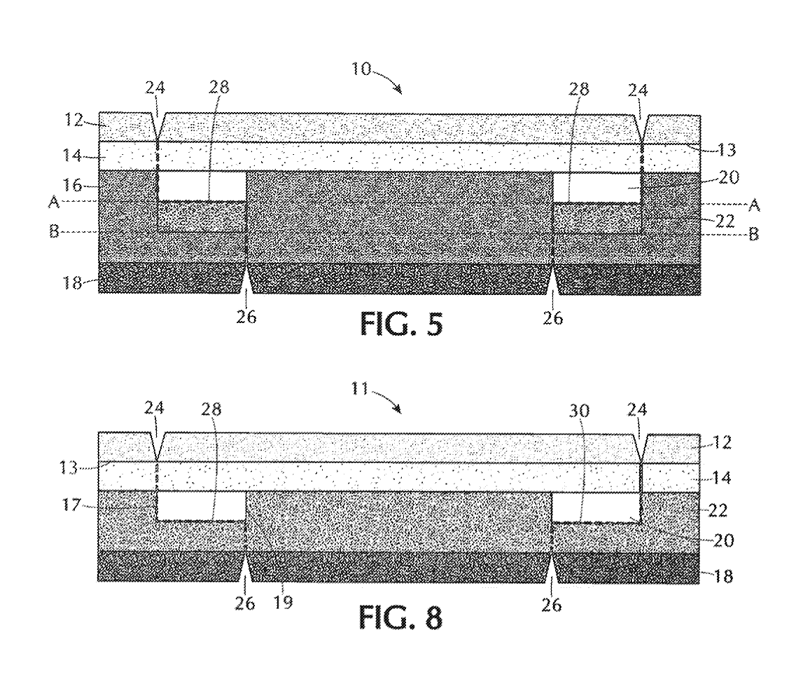

The removable portion 4 is configured to be separated from the remaining portion 3 of the package 100 along a separation interface 28 (see, e.g., FIGS. 2B, 3, 5, and 8 illustrating a separation interface) according to exemplary embodiments. In the closed position, the removable portion 4 is defined in the film of top panel 2 generally by a first line of weakness 24 and a second line of weakness 26 (see e.g., FIGS. 5 and 8). The first line of weakness 24 and the second line of weakness 26 are shown laterally offset, the first line of weakness 24 generally circumscribing the second line of weakness 26. To transition from the closed position to the open position, the removable portion 4 is separated along the first line of weakness 24 and the second line of weakness 26 to expose at least a portion of the pressure sensitive adhesive layer 22 and to define a mouth 6. The portion of the pressure sensitive adhesive layer 22 that is exposed coincides with a flange 5 (e.g., margin, lip, etc.) and is configured provide for sealing of the package 100 in the resealed position, as will be discussed in more detail below. As will also be discussed in more detail below, the removable portion is not utilized to reseal the package. In fact, the removable portion may be discarded once the package is transitioned from the closed position to the open position or be utilized other than for reseal (e.g., may provide product coupons or games for the consumer).

The removable portion is shown generally oval shaped in the present exemplary embodiment. According to other exemplary embodiments, however, the removable portion may be in any shape suitable for defining a mouth, including but not limited to: oval, circle, rectangle, square, triangle, and the like. It is generally desirable that the mouth be configured to allow a consumer to easily access to the package contents with their hand. Other suitable mouth configurations, include, but are not limited to those that allow a consumer to pour or dump out the contents of the package.

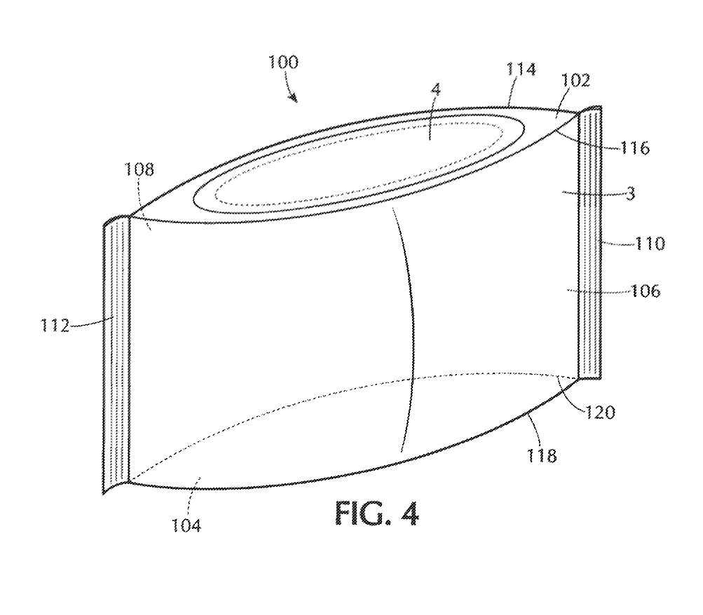

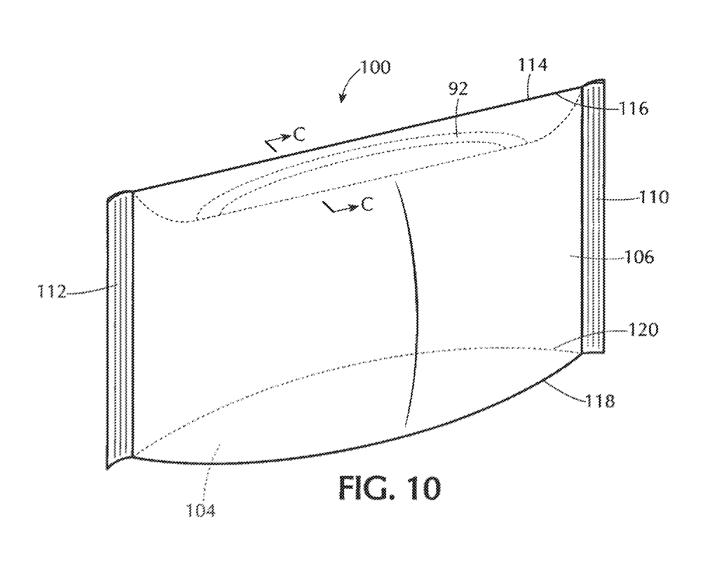

FIG. 4 shows the exemplary package 100 of FIG. 1 in a closed position, that is, for example, prior to any action by a consumer to remove the removable portion or access contents of the package. FIG. 10 shows a perspective view of the exemplary package of FIGS. 1 and 4 in a resealed position.

FIG. 5 shows an exemplary cross-section of the top panel 2 of package 100 shown in FIGS. 1, 4, and 10 detailing the structure of an intact film 10 from which the top panel 2 is formed. In addition to the interior layer 18, the exterior layer 12, the patterned release coating layer 20 and the pressure sensitive adhesive layer 22 that are discussed above, the film 10 of the top panel is shown further comprising an a laminating adhesive layer 16 and an ink layer 14. The laminating adhesive layer 16 is shown as a flood coated layer; it is directly adjacent to the interior layer 18 and extends generally from the ink layer 14 to the interior layer 18, surrounding the layers there between. Notably, the laminating adhesive layer 16 extends fully between the ink layer 14 and the interior layer 18 at the portion of the top panel 2 corresponding to what will be the mouth 6. The ink layer 14 is shown disposed on an inner surface 13 of the exterior layer 12. The ink layer 14 may be used, for example, to include graphics or promotional information.

In the present exemplary embodiment, the ink layer 14 is further configured to improve adhesion between the interior layer 18 and the pattered release coating layer 20. In this manner, the ink layer 14 may help ensure that the patterned release layer coating 20 is removed from the package 100 with the separation of the removable portion 4 and that the pressure sensitive adhesive layer 22 is exposed. According to one exemplary embodiment, the ink layer is polyurethane ink system, the interior layer is a polyethylene layer and the pattered release coating layer is a clay-modified varnish (e.g., FSBM1B6DB produced by Siegwerk Druckfarben AG & Co. KGaA). According to other exemplary embodiments, an ink layer need not be present. In these exemplary embodiments, as would be understood by one of skill in the art, the affinities of the remaining layers may be adjusted (as needed) to achieve the desired functionality.

Referring further to FIG. 5, the first line of weakness 24 and the second line of weakness 26 are shown each extending into the film 10 from generally opposing directions according to an exemplary embodiment. The first line of weakness 24 extends generally into the exterior layer 12 from the exterior surface of the film 10 towards the ink layer 14, but does not extend through to the interior layer 18. The second line of weakness 26 extends generally into the interior layer 18 from the interior surface of the film 10 towards the laminating adhesive layer 16, but does not extend through to the exterior layer 12. The first line of weakness 24 and the second line of weakness 26 are configured to facilitate separation of the removable portion 4 from the remaining portion 3 of the package 100 along the separation interface 28. That is, upon application of a peeling force to the removable portion 4, the first line of weakness 24 and the second line of weakness 26 begin to separate and generally help direct the separation of the removable portion 4 from the remaining portion 3 of the package 100 along the separation interface 28. This configuration affords substantial peeling control when opening the package 100 while still retaining the ability for the package 100 to be hermetically sealed in the closed position. As discussed above, the removable portion 4 of the top panel 2 is desirably fully removed from the package 100 when the package 100 is transitioned from the closed position to the open position. After the removable portion 4 is removed, the remaining portion 3 of package 100 is left, and the remaining portion 3 is all that is needed to transition between the open position and the resealed position.

According to an exemplary embodiment, the lines of weakness 24 and 26 are formed mechanically. For example, a blade or other cutting instrument may be used to mechanically remove or separate material from a film to form a generally linear void or absence of material (e.g., depression, cavity, concavity, pit, indentation, slit, etc.) to provide for an area that helps direct tear or peel. According to another exemplary embodiment, the lines of weakness may be formed using optical means (e.g., a laser). Moreover, while the lines of weakness 24, 26 are shown as substantially continuous lines, a line of weakness may be substantially defined by intermittent absences or voids of material suitable to provide a general line or path of weakness that provides for improved peeling (e.g., tearing, pulling, etc.) control. According to some exemplary embodiment, a rotary die cutter is used to create the lines of weakness. According to other exemplary embodiments, a combination of rotary die and optical equipment (e.g., lasers) is used to create the lines of weakness. According to still other exemplary embodiments, a platen die cutter is involved in creating the lines of weakness.

According to an exemplary embodiment, separation of the removable portion 4 of the top panel 2 may be facilitated by an optional peel tab. The peel tab may be configured to be gripped (e.g., held, pinched, etc.) by a consumer while applying a peeling force. The peel tab may be a portion of the removable portion 4 of the top panel 2 that is not sealed to the remaining portion 3. According to other exemplary embodiments, a peel tab may be any portion of the removable portion 4 at or above or near the line of weakness 24 that is unsealed and thereby facilitates application of a peeling force to achieve separation of the removable or peel-off portion. According to still other exemplary embodiments, the peel tab may be independently formed from the removable portion 4, but coupled thereto.

According to an exemplary embodiment, separation of the removable portion of the top panel 2 may be facilitated by the relative positions of the release coating and the pressure sensitive adhesive (e.g., the pressure sensitive adhesive being absent from a small area proximate the first line of weakness to facilitate starting the peel to remove the removable portion).

Referring back to FIG. 1 a first boundary 7 and a second boundary 8 are shown in the top panel 2 of the remaining portion 3 according to an exemplary embodiment. The first boundary 7 and the second boundary 8 are shown laterally offset, the first boundary generally circumscribing the second boundary. The flange 5 is shown substantially corresponding to this offset between the first boundary 7 and the second boundary 8. As will be discussed in more detail in relation to the FIGURES showing a resealed position, it is desirable for the shape of the flange to be substantially symmetrical about at least one axis (e.g., an axis within the plane of the top panel). Such a configuration facilitates forming a reseal seal by the sealing of one portion of the pressure sensitive adhesive layer to another portion of the pressure sensitive adhesive layer.

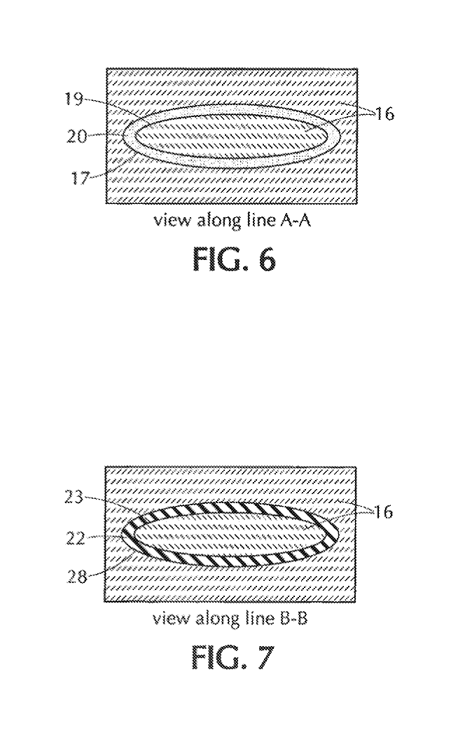

FIG. 6, which is a schematic plan view along line A-A of FIG. 5, provides additional detail regarding the structure of the film 10 used to form the top panel 2. The laminating adhesive layer 16 is shown surrounding the patterned release coating layer 20. The configuration of the patterned release coating layer 20 helps provide for definition of the flange 5 as well as for separation of the removable portion 4 from the remaining portion 3 when the package 100 is transitioned from the closed position to the open position. The release coating layer 20 has an inner boundary 19 and an outer perimeter 17. The inner boundary 19 generally defines the absence of the release coating. Further, the inner boundary 19 is shown substantially corresponding to the second boundary 8 and, accordingly, the perimeter or edge of the mouth 6. The outer perimeter 17 of the patterned release coating layer 20 is shown substantially corresponding to the first boundary 7.

According to some exemplary embodiments, the first boundary 7 also substantially corresponds to the first line of weakness 24. According to other exemplary embodiments, the second boundary 8 also substantially corresponds to the second line of weakness 26. According to still other exemplary embodiments, the first boundary 7 substantially corresponds to the first line of weakness 24 and the second boundary 8 substantially corresponds to the second line of weakness 26 (see, e.g., FIG. 5). As detailed in FIG. 7, which is a schematic plan view along line BB of FIG. 5, the film 10 used to form the top panel 2 comprises the laminating adhesive layer 16 surrounding the pressure sensitive adhesive layer 22, which is shown as a patterned or pattern-applied pressure sensitive adhesive layer. The pressure sensitive adhesive layer 22 as shown has an inner boundary 23 and an outer perimeter 28. The inner boundary 23 generally defines an absence of pressure sensitive adhesive and generally corresponds to the second boundary 8. The outer perimeter 28 generally corresponds to the first boundary 7.

Referring to FIGS. 5-7, the configuration of the patterned release coating layer 20 and pressure sensitive adhesive layer 22 facilitates separation of the removable portion 4 from the remaining portion 3. Moreover, the coordinated positions (e.g., placement, patterns, etc.) of the patterned release coating layer 22 and the pressure sensitive adhesive 22 help provide particularly good control over separation along the separation interface 28. Upon application of force to the removable portion 4 (e.g., at or proximate to the first boundary 7 and/or the second boundary 8), the patterned release coating layer 28 readily separates from pressure sensitive adhesive layer 22 (i.e., causes adhesive failure). The pressure sensitive adhesive layer 22 is proximate, or closer, to the interior layer 18 relative to the patterned release coating layer 20. In this way, when the pattern release coating layer 20 is removed from the package along with the removable portion 20, the pressure sensitive adhesive layer 22 remains as part of the remaining portion 3 of the package 100, exposed on the flange 5 so that it may be used for resealing the package 100. Notably, the absence of the patterned release coating layer 20 and the pressure sensitive adhesive layer 22 within their inner boundaries 19, 23 helps provide for creation of the mouth 6. That is, with removal of the removable portion 4, an entire cross-section (i.e., from the exterior layer through to the interior layer) of the film 18 is removed, the bonds among these layers being generally stronger than those between the patterned release coating layer 20 and the pressure sensitive adhesive layer 22. As discussed further below, this aspect of removal of the removable portion 4 is further facilitated by the second line of weakness 26, which substantially corresponds to the inner boundaries 19, 23 of the patterned release coating layer 22 and the pressure sensitive adhesive layer 22 in the present embodiment.

Referring further to FIGS. 5-7, the coordination of the lines of weakness of the film 10 with the layer configuration further facilitates desirable separation of the removable portion 4 from the remaining portion 3 along the separation interface 28. The position of the first line of weakness 24 helps initiate the separation of the removable portion 4 at a desirable location. The position of the second line of weakness helps complete the separation at a desirable location. The relative position of the lines of weakness helps provide for separation through the layers of film 10 (i.e., generally from the exterior layer 12 toward the interior layer 18) to occur in a desirable manner (i.e., along the separation interface 28, resulting in flange 5 and exposure of pressure sensitive adhesive, etc.).

As generally identified by the dashed bold lines in FIG. 5, the separation interface 28 generally extends from the first line of weakness 24 to the second line of weakness 26 according to an exemplary embodiment. Between the first line of weakness 24 and the second line of weakness 26, the separation interface 28 is shown to extend through the exterior layer 12, through the ink layer 14, along the interface of the patterned release coating layer 20 and the pressure sensitive adhesive layer 22, through the laminating adhesive layer 16, and through the interior layer 18.

For ease of manufacture and other functional considerations, the flange 5 is a continuous strip (as shown). According to other exemplary embodiments, however, the flange may not be continuous. In such exemplary embodiments, the flange is discontinuous but still configured to ensure the peelable flange can be resealed (e.g., by having generally opposing portions suitable for being brought together and aligned, thereby bringing opposing portions of the pressure sensitive adhesive layer together for reseal). For example, the flange may include two opposing, substantially crescent shaped portions; where there is a transition between the crescent-shaped portions, the first boundary and the second boundary substantially coincide. This may be suitable, for example, for applications where a hermetic seal is not required.

In some exemplary embodiments, the body 1 of the package 100 has a biased seam 9 (see, e.g., FIG. 1). The biased seam 9 helps direct opposing portions of the flange 5 towards one another. In this way, the biased seem 9 facilitates the transition of package 100 from an open position to a resealed position (see, e.g., FIG. 10). As will be discussed in more detail below, the biased seam 9 may be achieved using gusseted features or any other package design feature that helps direct generally opposing portions of the flange 5 towards one another.

FIG. 2A shows an exemplary a cross-section and FIG. 2B is an exemplary perspective cross-section of package 100 in the open position, as shown in FIG. 1, detailing the structure of the exemplary film 10 from which the top panel 2 is formed. In these views, the removable portion 4 has been separated from the remaining portion 3 of the package 100 along separation interface 28.

Referring generally to FIGS. 2A, 2B and 5, the removable portion 4 is shown comprising the release coating layer 20 along with segments of the exterior layer 12, the ink layer 14, the laminating adhesive layer 16, and the interior layer 18. The remaining portion 3 is shown comprising the pressure sensitive layer 22 along with sections of the exterior layer 12, the ink layer 14, the laminating adhesive layer 16 and the interior layer 18. Once the package 100 is open as shown in FIGS. 2A and 2B, the removable portion 4 is no longer needed for the continued functionality of the package. Stated otherwise and as discussed above, the removable portion 4 is not needed to transition the package 100 between the open position and the reseal position. It is the pressure sensitive adhesive layer 22 that is exposed when transitioning from the closed position to the open position that provides for the reseal functionality. As is discussed in more detail later, generally opposing portions of the pressure sensitive adhesive layer 22 at the flange 5 come together to achieve reseal, the pressure sensitive adhesive sealing to itself. According to other exemplary embodiments, however, the pressure sensitive adhesive need not extend around the entire flange to effect reseal. For example, the pressure sensitive adhesive may be exposed on half of the flange. In such an embodiment, the pressure sensitive adhesive would adhere to other half of the flange not including pressure sensitive adhesive when in the reseal position (e.g., to the laminating adhesive layer or interior layer).

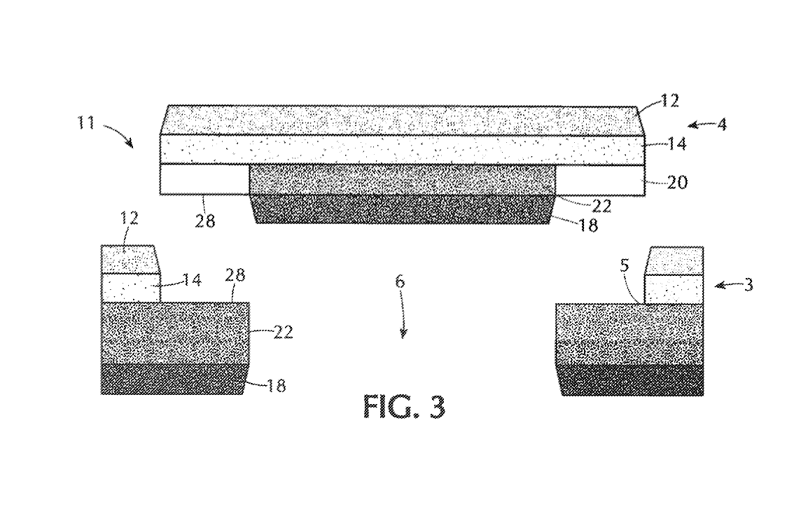

FIGS. 8 and 3 show cross-sectional views of another exemplary embodiment of a film 11 used to form a resealable flexible package. In contrast to the exemplary embodiment of FIGS. 2A, 2B, and 5, the present exemplary embodiment does not include a laminating adhesive layer and the pressure sensitive adhesive layer 22 is a flood coated layer.

Referring to FIG. 8 in particular, the package is shown in a closed position. The layer structure of exemplary film 11 is shown including an exterior layer 12, an ink layer 14 disposed on the inner surface of the exterior layer 12, a patterned release coating layer 20 adjacent to the optional ink layer 14, a pressure sensitive adhesive layer 22 that is flood-coated, and an interior layer 18. In addition to being directly adjacent to the interior layer 18, the pressure sensitive adhesive layer 22 is adjacent to the patterned release coating layer 20 and the ink layer 14.

The first line of weakness 24 and the second line of weakness 26 are shown each extending generally into the film 11 from generally opposing directions. The first line of weakness 24 extends generally into the exterior layer 12 from the exterior surface of the film 11 towards the optional ink layer 14, but not extending through to the interior layer 18. The second line of weakness 26 extends generally into the interior layer 18 from the interior surface of the film 11 towards the pressure sensitive adhesive layer 22, but not extending through to the exterior layer 12. The first line of weakness 24 circumscribes the second line of weakness 26 in this embodiment.

The first line of weakness 24 and the second line of weakness 26 are configured to facilitate separation of the removable portion 4 from the remaining portion 3 of the package 100 along a separation interface 30. That is, upon application of force to the first line of weakness 24 and the second line of weakness 26, the removable portion 4 separates from the remaining portion 3 of the package 100 along the separation interface 30. This configuration affords improved peeling control when opening the package 100 as well as the ability for the package 100 to be hermetically sealed in the closed position. As discussed above, the removable portion 4 of the top panel 2 is removed from the package 100 when the package 100 is transitioned from the closed position to the open position. The remaining portion 3 of the body 1 remains after the removable portion 4 is removed from the package 100.

Referring to FIG. 3 in particular, similar to exemplary film 10, the configuration of the patterned release coating layer 20 and pressure sensitive adhesive layer 22 of film 11 facilitates separation of the removable portion 4 from the remaining portion 3. That is, upon application of force to the removable portion 4 (e.g., at or proximate to the first boundary 7 and/or the second boundary 8), the patterned release coating layer 20 readily separates from the adjacent portion of the pressure sensitive adhesive layer 22. In the embodiment shown, the adjacent portion of the patterned release coating layer 20 and the pressure sensitive adhesive layer 22 when the package is in the closed position generally corresponds to the location of the flange 5 when the package is in the open position. In this way, when the pattern release coating layer 20 is removed from the package along with the removable portion 20, the portion of the pressure sensitive adhesive layer 22 generally corresponding to the flange 5 remains as part of the remaining portion 3 of the package 100, available for reseal.

Referring to FIGS. 3 and 8, the lines of weakness of the film 11 in addition to the configuration of the layers further facilitates desirable separation of the removable portion 4 from the remaining portion 3 along the desired separation interface 30. The position of the first line of weakness 24 helps initiate the separation of the removable portion 4 at a desirable location. The position of the second line of weakness 26 helps complete the separation of the removable portion 4 at a desirable location. The relative position of the lines of weakness 24, 26 helps provide for separation through the layers of film 11 to occur in a desirable manner (i.e., along the separation interface 30, resulting in flange 5 and exposure of pressure sensitive adhesive, etc.). As generally identified by the dashed bold lines in FIG. 8, the separation interface 30 generally extends from the first line of weakness 24 to the second line of weakness 26. Between the first line of weakness 24 and the second line of weakness 26, the separation interface 30 extends through the exterior layer 12, extends through the ink layer 14, extends along the interface of the patterned release coating layer 20 and the pressure sensitive adhesive layer 22, extends through the pressure sensitive adhesive 22 toward the interior layer 18, and extends through the interior layer 18 at a location corresponding to the second line of weakness 26.

In contrast to exemplary film 10, it is not the combined absence of the patterned release coating layer 20 and the pressure sensitive adhesive layer 22 within their inner boundaries 19, 23 that helps provide for creation of the mouth 6. Rather, the combination of features of film 11 that provide for creation of a mouth 6 include the absence of patterned release coating 20 within its inner boundary 19, the second line weakness 26, and the bonds strengths. With regard to the relative bond strengths, the bond between the pressure sensitive adhesive layer 22 and the ink layer 14, as well the bond between the pressure sensitive adhesive layer 22 and the interior layer 18, are generally stronger than those between the patterned release coating layer 20 and the pressure sensitive adhesive layer 22.

While the removable portion 4 of exemplary films 10 and 11 function in and are removed in a substantially similar manner, the removable portion 4 of the film 11 includes a significant segment of the pressure sensitive adhesive layer 22 in contrast to the film 10. Referring further to FIGS. 3 and 8, the removable portion 4 is shown comprising the release coating layer 20 along with segments of the exterior layer 12, the ink layer 14, the pressure sensitive adhesive layer 22, and the interior layer 18. The remaining portion 3 is shown comprising sections of the pressure sensitive layer 22, the exterior layer 12, the ink layer 14, and the interior layer 18. As with exemplary film 10, the removable portion 4 of exemplary film 11 is no longer needed for the continued functionality of the package 100 once it is removed. Stated otherwise and as discussed above, the removable portion 4 is not needed to transition the package 100 between the open position and the reseal position. It is the pressure sensitive adhesive layer 22 that is exposed when transitioning from the closed position to the open position that provides for the reseal functionality.

The flange 5 is shown comprising a portion of the pressure sensitive layer. The separation interface 30 is formed upon application of force to the first line of weakness 24 and the second line of weakness 26. Separation occurs laterally between the release coating 20 and the pressure sensitive adhesive layer 22 as well as vertically through the interior layer 18, the laminating adhesive layer 16, the optional ink layer 14, and the exterior layer 12, thereby permitting easy removal of the removable portion 4 to expose the mouth 6.

The functionality of a package provided for by the elements described above is now discussed in more detail in relation to exemplary package 100.

FIG. 4 shows the exemplary package 100 of FIG. 1 in a closed position; that is, for example, prior to any action by a consumer to remove the removable portion or access contents of the package. FIG. 10 shows a perspective view of the exemplary package of FIGS. 1 and 4 in a resealed position.

With reference to FIGS. 1, 4 and 10, as applicable, the flexible package 100 comprises a top wall 102, a bottom wall 104, a first side wall 106, and a second side wall 108 according to an exemplary embodiment. The bottom wall 104 is shown generally opposite the top wall 102. The first side wall 106 and the second side wall 108 are shown generally opposite to each other. The first side wall 106 is generally perpendicular to the top and bottom walls 102 and 104, respectively. A first side/lengthwise heat seal 110 affixes the first and second side walls 106 and 108 at one side to each other. A second side/lengthwise heat seal 112 affixes the first and second side walls 106 and 108 at the other side to each other. A first edge/widthwise heat seal 114 affixes the top wall 102 to the side wall 108. A second edge/widthwise heat seal 116 affixes the top wall 102 to the side wall 106. A third edge/widthwise heat seal 118 affixes the bottom wall 104 to the side wall 106. A fourth edge/widthwise heat seal 120 affixes the bottom wall 104 to the side wall 108. The side walls 106 and 108 along with bottom wall 104 are configured to remain intact (e.g., not tear or otherwise fail) when the package 100 is transitioned from the closed position to the open position. This exemplary design allows for formation of walls of package 100 from a single film material, and, in fact, a single piece of said film material. Though, according to alternative embodiments, more than one type of film material may be used to construct a package.

Referring to FIG. 4, the top wall 102 is shown formed from a film that comprises a removable portion 4. The removable portion 4 is separated to transition the package 100 from the closed position to the open position. Separation of the removable portion is accomplished by application of a peeling force (e.g., by a consumer). Application of the peeling force results in the removable portion 4 separating along the desirable separation interface, thereby defining the mouth and exposing pressure sensitive adhesive on the flange 5.

FIG. 1 shows the removable portion 4 fully removed. The flange 5 is defined and the pressure sensitive adhesive layer 22 is exposed thereon. In this position, a consumer may access product in the package 100. A consumer wanting to reseal the package 100 moves two generally opposing portions of the flange 5 toward one another, bringing them into contact (e.g., pinching them, pushing them, pressing them, etc.), as shown in FIG. 10. When brought into contact, the portions of the pressure sensitive adhesive layer 22 corresponding to the opposing portions of the flange 5 seal to one another, forming a seal (or sealed flange) 92. Application of pressure may further establish the seal 92. Thus, the removable portion 4 is not needed for reseal. Reseal is achieved solely with remaining features of the same film from which the removable portion formed and removed.

FIG. 15 shows a partial cross-sectional view of a sealed flange area 90 including the seal 92 of the package 100 of FIG. 10 taken along line C-C wherein the package 100 is made with the film 10 (see, e.g., FIG. 2A) according to an exemplary embodiment. Two portions or sections of the flange 5 having exposed portions of the pressure sensitive adhesive layer 22 are shown in contact and forming a seal (or sealed flange) 92. The seal 92 provides for retention of product within the package 100. To transition the package 100 back to the open portion from the resealed position, the portions of the flange 5 brought together to form seal 92 can be pulled apart (e.g., by applying a force to each portion, the forces being in generally opposing directions, such as opposite the directions of the arrows as shown), breaking the seal between the portions of pressure sensitive adhesive layer 22 so that product can again be accessed through the mouth 6. In this manner, the seal 92 may subsequently be opened and resealed as needed to access or store contents of the package.

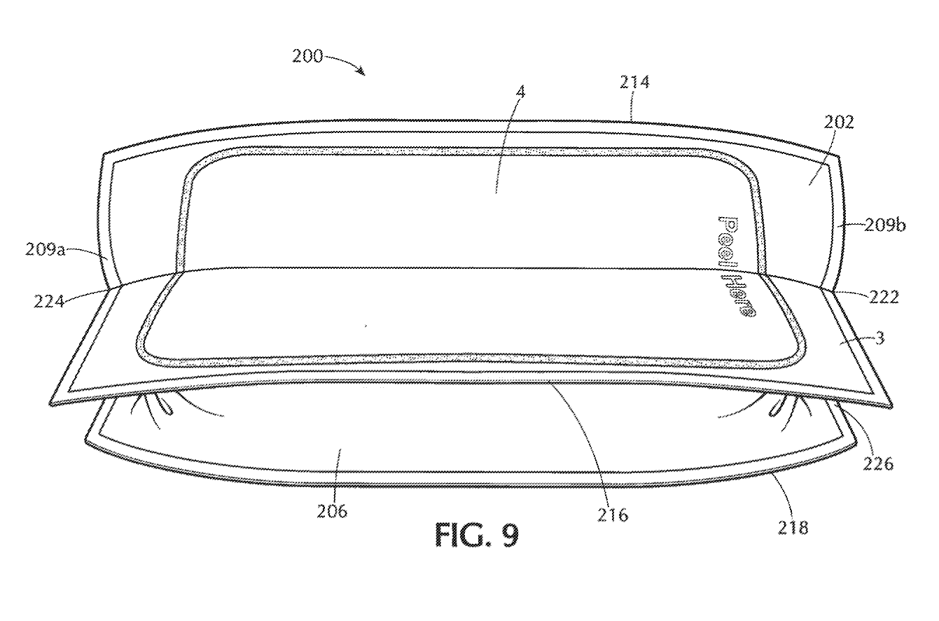

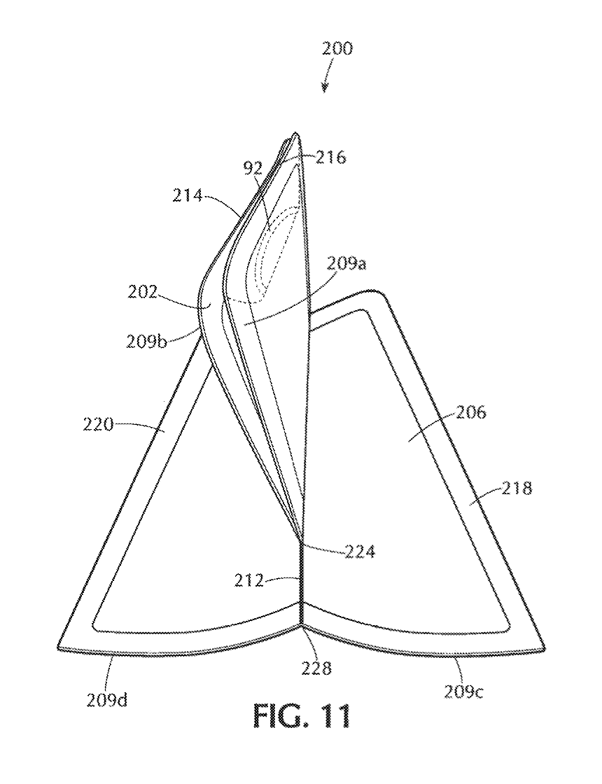

FIGS. 9 and 11 show a perspective view of another exemplary flexible package 200 that is a gusseted package. The flexible package 200 includes a top wall 202, a bottom wall (not shown in this view), a first side wall 206, and a second side wall (not shown in this view). The top wall 202 includes removable portion 4 according to an exemplary embodiment. The top wall 202 is formed from an exemplary film, such as film 10 or film 11. The bottom wall is generally opposite the top wall 202. The first side wall 206 is generally opposite a second side wall. The first side wall 206 is also generally perpendicular to the top wall 202 and the bottom wall.

FIG. 9 shows package 200 including gusseted features 222 and 224 that are shown as biased seams. The gusseted features 222 and 224 are configured to facilitate reseal by directing the flange toward itself (e.g., inward). As shown, the gusseted features 222 and 224 help provide a natural bend along a line generally corresponding to a line of symmetry of the removable portion 4 and the flange 5.

In this exemplary embodiment, a first gusseted feature 222 is shown incorporated into a side/lengthwise heat seal of the package, affixing the top wall 202 to the side walls and forming first biased seam 209b. A second gusseted feature 224 is shown incorporated into the other side/lengthwise heat seal of the package, affixing the top wall 202 to the side walls and forming second biased seam 209a. Gusseted features may also be incorporated into side/lengthwise heat seals of the package, affixing the bottom wall 204 to the side walls. A first edge/widthwise heat seal 214 affixes the top wall 202 to a side walls. A second edge/widthwise heat seal 216 affixes the top wall 202 to the other side wall 206. A third edge/widthwise heat seal 218 affixes the bottom wall to the side wall 206. A fourth edge/widthwise heat seal (not shown) affixes the top wall 202 to the other side wall.

Turning to FIG. 11, after the removable portion has been fully removed and the flange of the top wall 202 is pressed together to form a seal (or sealed flange), discussed previously with respect to FIG. 15.

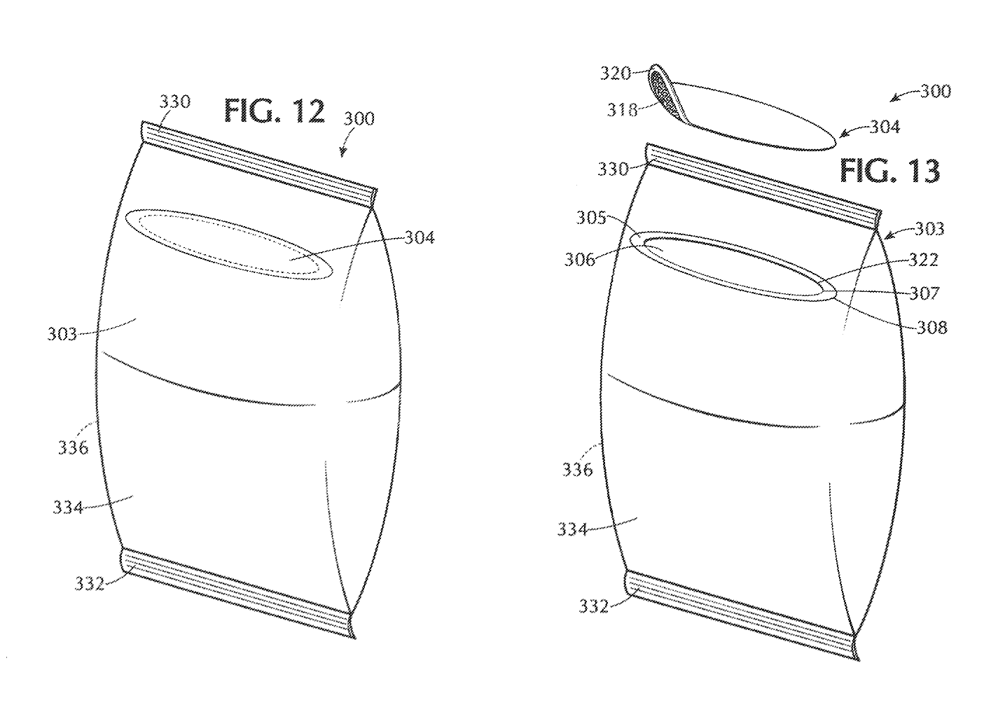

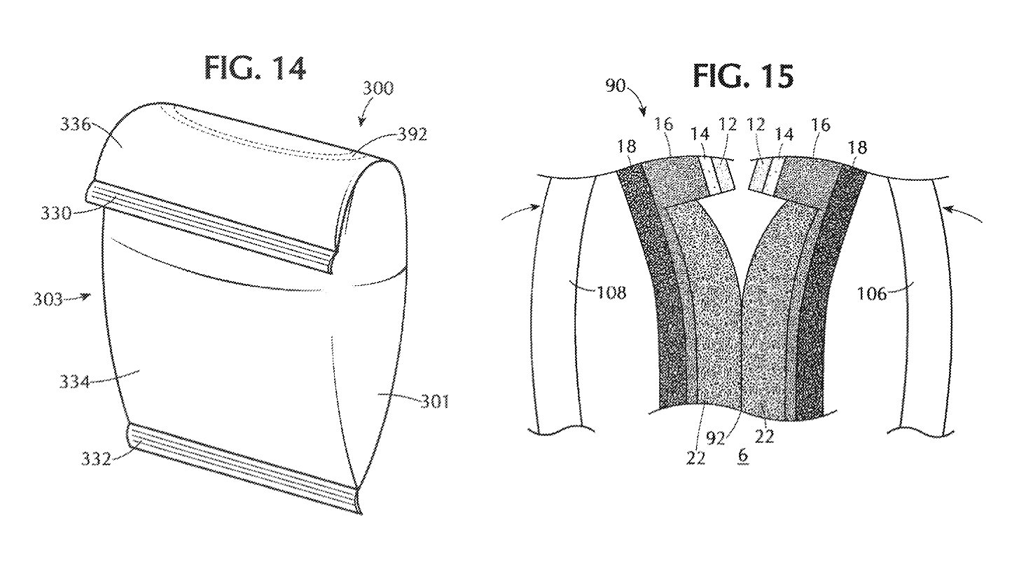

FIGS. 12-14 provide top perspective views of another exemplary package in closed, open, and resealed positions, respectively. In these embodiments, the package is essentially a tubular structure formed from a multilayered film having a removable portion. The package 300 includes a tubular body 301, a remaining portion 303 and a removable portion 304. The body 301 has a forward panel 334 and a backside panel 336 (as shown, coupled by edge/widthwise heat seals 330 and 332). In FIG. 13, the removable portion 304 is shown separated from the remaining portion 303 and at least a portion of a pressure sensitive adhesive layer 322 is exposed on a flange 305 of the remaining portion 303. In FIG. 14, the removable portion (not shown) remains fully removed and opposing portions of the flange 305 are pressed together such that the pressure sensitive adhesive forms a seal (or sealed flange). To bring the opposing portions of the flange 305 together, the backside panel 336 is folded over (e.g., over heat seal 330) and the forward panel 334 folds onto itself (i.e., into contact with itself).

According to other exemplary embodiments, a removable portion may extend between two or more sides of a flexible package. In such a configuration, the flange (and the pressure sensitive adhesive thereon) would extend between/along two or more sides of the flexible package. Accordingly, reseal would involve bringing opposing parts of the flange together from different side walls of a flexible package.

Methods of manufacturing exemplary films and packages according to this disclosure will now be discussed.

In general terms, to form embodiments of the packages disclosed herein, the following steps are used. A multi-layered film with a removable portion as described above is formed. A package is formed or assembled from the multi-layered film. In one or more embodiments, the package is formed from a continuous piece of film. In other embodiments, the film forms a wall panel, or other portion of a flexible package suitable to accommodate the removable portion of the flexible package and the rest of the package is made from a different film.

According to an exemplary embodiment, in-line press/laminator (roto or flexo press) (e.g., an adhesive laminator or an extrusion laminator) is used to prepare a multi-layered film or web.

According to an exemplary embodiment, a vertical-form-fill-seal (VFFS) machine is used to form or assemble the package using the multi-layered film. According to other exemplary embodiments, any machine suitable for forming a flexible package as described herein may be used, as will be understood by a person of skill in the art.

A method of manufacturing a multilayer film or web of the present disclosure is a laminating method according to an exemplary embodiment. The multilayer film or web of the present disclosure includes an exterior layer, an ink layer, a release coating layer, a pressure sensitive adhesive layer, a layer of laminating adhesive or extrudate, and an interior layer according to an exemplary embodiment. The method includes the steps of applying the ink layer to the interior surface of the exterior layer. The method further includes applying the release coating layer followed by the pressure sensitive adhesive layer. In some exemplary embodiments, the release coating layer is pattern applied and the pressure sensitive adhesive layer is also pattern applied. The release coating layer and the pressure sensitive adhesive may be pattern applied using rotogravure or flexographic printing as part of the lamination process. After application of the release coating layer and the pressure sensitive adhesive layer, the laminating adhesive or extrudate layer is flood coat applied such that it forms a substantially continuous layer (e.g., fills in around and above the release coating layer and the pressure sensitive adhesive layer). An interior layer is thereafter laminated to the laminating adhesive or extrudate layer.

For efficiency purposes, lines of weakness can formed at the same time as slitting, depending on the equipment available, on both the outermost and innermost layers. Alternatively, the lines of weakness may be formed at a later time, prior to forming the package (e.g., after printing and laminating as described above). The lines of weakness may be formed by methods known in the art and may be formed by the same or different methods. Exemplary methods for forming the lines of weakness include, but are not limited to, laser scoring, die cutting—including rotary die cutting, platen die cutting, perforation cutting, kiss-cutting, or mechanical cutting, to further define the removable portion. The choice of method may depend on the type of material being used (e.g., oriented versus non-oriented materials because it is desirable to have controlled separation of the removable portion in both the machine direction and the cross machine direction).

According to an exemplary embodiment, the lamination process is an in-line press lamination.

According to an exemplary embodiment the lamination process is an adhesive lamination process. According to other exemplary embodiments, the lamination process is an extrusion lamination process or any other manufacturing method known by those of skill in the art suitable for forming films according to the present disclosure.

According to an exemplary embodiment, an ink layer functions as a primer layer in addition to providing its typical printing benefits.

According to an exemplary embodiment, an ink layer may be provided as desired on a surface of the outermost layer using flexographic or roto-gravure or ink jet printing techniques, as is known in the art. Desirably, the ink is reverse-printed on an inner surface of the outermost layer. Though, according to other exemplary embodiments, an ink layer may be printed on an outer surface of the outermost layer.

According to an exemplary embodiment, the exterior or outermost layer is an oriented film. Oriented films can provide beneficial tear properties (i.e., helping the separation interface propagate along a desired path), particularly when used with certain types of lines of weakness (e.g., a line of weakness formed by scoring). Exemplary oriented films include oriented polyethylene terephthalate and oriented polypropylene. According to other exemplary embodiments, the exterior film need not be oriented, but, rather, may comprise any material suitable for a given packaging application (e.g., a barrier film, polypropylene, paper, etc.).

According to an exemplary embodiment, the release layer is release varnish FSBM1B6DB produced by Siegwerk Druckfarben AG & Co. KGaA. According to other exemplary embodiments, the release layer may be any coating suitable to function as described in the above exemplary embodiments as would be understood by a person of skill in the art.

According to some exemplary embodiments, the film does not include an ink layer and, accordingly, the method of manufacturing does not include the step of applying an ink layer.

According to alternative embodiments, the laminating adhesive layer is also pattern applied. For example, the release coating layer and pressure sensitive adhesive layers are pattern applied and then the laminating adhesive layer is pattern applied, the laminating adhesive layer filling in around the release coating layer and the pressure sensitive adhesive layer until it is substantially level with the pressure sensitive adhesive layer.

A method of manufacturing a multilayer film of web of the present disclosure is a laminating method according to another exemplary embodiment. In this exemplary embodiment the pressure sensitive adhesive is flood coated and there is no separate laminating adhesive or extrudate layer. Accordingly, the method includes the steps of applying the ink layer to the interior surface of the exterior layer, applying the release coating layer, applying the pressure-sensitive adhesive layer by flood coating, and laminating the interior layer to the pressure sensitive adhesive layer. According to an alternative exemplary embodiment, the film does not include an ink layer and, accordingly, the method of manufacturing does not include the step of applying an ink layer.

The method of manufacturing a flexible package according to the present disclosure may be conducted in according to any suitable manufacturing method as would be understood by one of skill in the art. For example, a vertical form-fill-seal process, a horizontal form-fill-seal process, thermoform fill-seal process and flow wrap process may be used.

The following terms are used herein:

As utilized herein, the terms “approximately,” “generally,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features (e.g., to the precise numerical ranges provided). Accordingly, these terms should be interpreted as indicating that insubstantial or inconsequential modifications or alterations of the subject matter described and claimed are considered to be within the scope of the invention as recited in the appended claims.

The term “film” is used in the generic to include polymeric web, regardless of whether it is a film or sheet.

A “layer” as used herein refers to a building block of a film that is a structure of a single-type of material or a structure that serves a common function, but may include one or more types of materials. In general, the layers of a film or substrate may comprise a single polymer, a mixture of a single polymer and non-polymeric materials, a combination of two or more polymeric materials blended together, or a mixture of a blend of two or more polymeric materials and non-polymeric materials (e.g., paper). As used herein, the term “multilayer” refers to a plurality of layers in a single film generally in the shape of a sheet or web which can be made from a polymeric material or a non-polymeric material bonded together by any conventional means known in the art (i.e., coextrusion, extrusion coating, and lamination, vacuum vapor deposition coating, solvent coating, or suspension coating or any suitable combination of one or more thereof).

As used herein, the term “seal” refers to the coupling or connection of one surface (or any portion thereof) with another surface (or any portion thereof) by any suitable means. Sealing may occur by heat or adhesive, for example. When heat and pressure are used, a “heat seal” is formed as discussed next. When adhesive is used, the seal may generally be unsealed and resealed.

As used herein, the term “heat seal” refers to the union of a surface (or portion thereof) of one film to a surface (or portion thereof) of another film or two different portions of a surface of the same film using heat and pressure. The heat-seal is achieved by bringing two surfaces or portion of a surface into contact, or at least close proximity, with one another and then applying sufficient heat and pressure to a predetermined area of the two surfaces to cause the contacting surfaces to become molten and intermix with one another, thereby forming an essentially inseparable fusion bond between the two surfaces in the predetermined area when the heat and pressure are removed therefrom and the area is allowed to cool.

As used herein, the term “peelable” means that the separation may be achieved with application of a peel force within the range of 200 grams/inch to 2250 grams/inch, even more preferably 650 gram/inch to 1300 grams/inch.

As used herein, the term “barrier material” refers to an oxygen and/or water vapor barrier material. Barrier materials used in packaging film include, for example, polyvinyl alcohol copolymers, ethylene vinyl alcohol copolymers, polyvinyl chlorides, polyvinylidene chloride/methyl acrylate copolymers, polyester homopolymers and copolymers, polyolefin homopolymers and copolymers such as polypropylene, polyethylene, preferably, high density polyethylene, metals such as aluminum, zinc, nickel, copper, bronze, gold, silver, tin or alloys thereof, metal oxides, organometallic compounds, ceramics and mixtures thereof.

As used herein, the terms “polymeric” and “polymer” refers to the product of a polymerization reaction, and is inclusive of homopolymers, copolymers, terpolymers, etc.

As used herein, the term “copolymer” refers to polymers formed by the polymerization of reaction of at least two different monomers. As used herein, a copolymer identified in terms of a plurality of monomers, e.g., “propylene/ethylene copolymer”, refers to a copolymer in which either monomer may copolymerize in a higher weight or molar percent than the other monomer or monomers. However, the first listed monomer preferably polymerizes in a higher weight percent than the second listed monomer.

As used herein, terminology employing a “/” with respect to the chemical identity of a copolymer (e.g., ethylene/vinyl alcohol copolymer), identifies the comonomers that are copolymerized to produce the copolymer.

As used herein, the term “polyester” refers to homopolymers or copolymers having an ester linkage between monomer units which may be formed, for example, by condensation polymerization reactions between a dicarboxylic acid and a glycol. The ester can be represented by the general formula: [R—C(O)O—R′]ₙ Where R and R′=alkyl group and may be generally formed from the polymerization of dicarboxylic acid and diol monomers or monomers containing both carboxylic acid and hydroxy moieties.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

The term “adhesive layer,” or “adhesive coating,” or “pressure sensitive adhesive layer” refers to a material placed on one or more layers, partially or entirely, to promote the adhesion of that layer to another surface. Preferably, adhesive layers or coatings are positioned between two layers of a multilayer film to maintain the two layers in position relative to each other and prevent undesirable delamination. Unless otherwise indicated, an adhesive layer or coating can have any suitable composition that provides a desired level of adhesion with the one or more surfaces in contact with the adhesive layer material. Optionally, an adhesive layer or coating placed between a first layer and a second layer in a multilayer film may comprise components of both the first layer and the second layer to promote simultaneous adhesion of the adhesive layer to both the first layer and the second layer to opposite sides of the adhesive layer.

Between any of the layers, an adhesive coating or layer may be provided to provide adhesion and continuity between the layers. Adhesive compositions invention may include, but are not limited to: modified and unmodified polyolefins, preferably polyethylene, and most preferably, ethylene/α-olefin copolymer, modified and unmodified acrylate resin, preferably selected from the group consisting of ethylene/vinyl acrylate copolymer, ethylene/ethyl acrylate copolymer, ethylene/butyl acrylate copolymer, or blends thereof. EVA is an ethylene/vinyl acetate co-polymer, which may be used in particular to form a layer to facilitate bonding of polymerically dissimilar layers.

Adhesive coatings may be water-based or solvent-based or solventless. Adhesive coatings may be one-component or two-part or have multiple ingredients.

Turning to the FIGURES, references herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the package as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

The construction and arrangement of the elements of the package as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A resealable flexible package including a closed position, an open position and a resealed position, wherein the package comprises:
a film including at least an exterior layer and an interior layer;
at least one wall formed from the film, the wall comprising:
a first line of weakness extending generally into the exterior layer;
a second line of weakness extending generally into the interior layer;
a patterned release coating layer disposed generally between the exterior layer and the interior layer; and
a pressure sensitive adhesive layer disposed at least generally between the patterned release coating layer and the interior layer;
wherein in the closed position, a removable portion is defined in the film generally by the first line of weakness and the second line of weakness;
wherein in the open position, the removable portion is separated along the first line of weakness and the second line of weakness to expose at least a portion of the pressure sensitive adhesive layer and to define a mouth; and
wherein in the resealed position, at least two sections of the exposed portion of the pressure sensitive adhesive layer are in contact to seal the mouth.

2. The resealable flexible package of claim 1, wherein the patterned release coating layer generally corresponds to a lateral offset between the first line of weakness and the second line of weakness.

3. The resealable flexible package of claim 1, wherein the pressure sensitive adhesive layer is a patterned pressure sensitive adhesive layer.

4. The resealable flexible package of claim 3, wherein the patterned pressure sensitive adhesive layer at least generally corresponds to a lateral offset between the first line of weakness and the second line of weakness.

5. The resealable flexible package of claim 1, wherein the wall further comprises a laminating adhesive layer directly adjacent to the interior layer.

6. The resealable flexible package of claim 1, wherein, in the resealed position, the removable portion of the wall is fully separated and not involved in reseal.

7. The resealable flexible package of claim 1, wherein the first line of weakness circumscribes the second line of weakness.

8. The resealable flexible package of claim 1, wherein the wall comprises a gusseted feature.

9. The resealable flexible package of claim 1, wherein a flange including the exposed portion of the pressure sensitive adhesive layer surrounds the mouth.

10. A resealable flexible package comprising:
a multilayered film defining at least one wall;
a first line of weakness extending into at least the outermost layer of the multilayer film;
a second line of weakness extending into at least the innermost layer of the multilayer film, the second line of weakness circumscribed by the first line of weakness;
a pressure sensitive adhesive layer having at least a portion disposed generally between the first line of weakness and the second line of weakness; and
a removable portion of the multilayer film defined generally by the first line of weakness and the second line of weakness;
wherein upon removal of the removable portion, a mouth of the package is defined and at least a portion of a pressure sensitive adhesive layer of the film is exposed.

11. The resealable flexible package of claim 10, wherein the removable portion is separated from a remaining portion of the package along a separation interface, the separation interface including an interface between the pressure sensitive adhesive layer and a patterned release coating layer, the interface of the pressure sensitive adhesive layer and the patterned release coating layer being generally between the first line of weakness and the second line of weakness.

12. The resealable flexible package of claim 10, wherein the removable portion is separated from a remaining portion of the package along a separation interface, the separation interface extending completely through the multilayer film at a location substantially corresponding to the second line of weakness.

13. The resealable flexible package of claim 10, wherein the outermost layer is an oriented film.

14. A multilayer film for a resealable flexible package, the film comprising:
an exterior layer;
an interior layer;
a patterned release coating layer disposed generally between the exterior layer and the interior layer;
a pressure sensitive adhesive layer disposed adjacent to the patterned release coating layer, the pressure sensitive adhesive layer being generally proximate the interior layer relative to the patterned release coating layer;
a first boundary circumscribing a second boundary, the second boundary substantially corresponding to an inner boundary of the patterned release coating layer within which there is an absence of the patterned release coating layer; and
an interface along which the patterned release coating layer and the pressure sensitive adhesive layer are separated to define a flange.

15. The multilayer film for a resealable package of claim 14, wherein the interface substantially corresponds to an offset between the first boundary and the second boundary.

16. The multilayer film for a resealable flexible package of claim 14, wherein the patterned release coating layer further includes an outer perimeter, the outer perimeter generally corresponding to the first boundary.

17. The multilayer film for a resealable flexible package of claim 16, wherein the pressure sensitive adhesive layer further includes an inner boundary, there being an absence of pressure sensitive adhesive within the inner boundary.

18. The multilayer film for a resealable flexible package of claim 17, wherein the inner boundary of the pressure sensitive adhesive layer generally corresponds to the second boundary.

19. The multilayer film for a resealable flexible package of claim 14, further comprising a first line of weakness extending generally into the exterior layer and substantially corresponding to the first boundary.

20. The multilayer film for a resealable flexible package of claim 14, further comprising a second line of weakness extending generally into the interior layer and substantially corresponding to the second boundary.

21. The multilayer film for a resealable flexible package of claim 14, further comprising a laminating adhesive layer.

22. The multilayer film for a resealable flexible package of claim 14, further comprising an ink layer on an inner surface of the exterior layer.

23. A resealable flexible package comprising:
a top panel comprising a film that includes a release coating layer and a pressure sensitive adhesive layer that are between at least an exterior layer of the film and an interior layer of the film; and
a body;
wherein the top panel has a peelable margin comprising a portion of the interior layer and at least a portion of the pressure sensitive adhesive layer, the peelable margin defining a mouth for access to the inside of the package;
wherein the top panel has at least one biased seam generally corresponding to a line of symmetry of the peelable margin.
